(19) United States
(12) Patent Application Publication
(10) Pub. No.: US 2026/0180153 A1
(43) Pub. Date: Jun. 25, 2026

(54) Microstrip Filter, Electronic Device and Indoor Distribution System

(71) Applicants: Beijing BOE Technology Development Co., Ltd., Beijing (CN); BOE Technology Group Co., Ltd., Beijing (CN)

(72) Inventors: Zongmin LIU, Beijing (CN); Feng WANG, Beijing (CN); Junwei GUO, Beijing (CN)

(21) Appl. No.: 18/711,627

(22) PCT Filed: Aug. 29, 2023
(86) PCT No.: PCT/CN2023/115552

§ 371 Date: May 20, 2024

(51) Int. Cl. H01P 1/203; H01Q 9/04

(52) U.S. Cl. CPC H01P 1/203; H01Q 9/0407; H01Q 9/0414

(57) ABSTRACT

A microstrip filter includes a first substrate (11) and a second substrate (12) disposed oppositely, and a dielectric layer (13) disposed between the first substrate (11) and the second substrate (12). The first substrate (11) includes a first base substrate (110) and a patch array disposed on a side of the first base substrate (110) close to the dielectric layer (13). The second substrate (12) includes a second base substrate (120), a microstrip line (121) disposed on a side of the second base substrate (120) close to the dielectric layer (13), and a ground layer (122) disposed on a side of the second base substrate (120) away from the microstrip line (121). The microstrip line (121) includes a main transmission line (1211) and at least one branch (1212). An orthographic projection of the branch (1212) of the microstrip line (121) on the first base substrate overlaps with an orthographic projection of the patch array on the first base substrate (110), and the dielectric layer (13) is configured to adjust a resonant frequency between the patch array and the microstrip line (121) when a voltage is applied to the patch (111) of the patch array.

### CROSS-REFERENCE TO RELATED APPLICATION

The present application is a U.S. National Phase Entry of International Application PCT/CN 2023/115552 having an international filing date of Aug. 29, 2023, and entitled “Microstrip Filter, Electronic Device and Indoor Distribution System”, the contents of which are hereby incorporated by reference in their entireties.

### TECHNICAL FIELD

The present application relates to, but is not limited to, the field of communication technology, in particular to a microstrip filter, an electronic device and an indoor distribution system.

### BACKGROUND

A filter is an electronic device or circuit used to selectively allow signals to pass through or block signals within a specific frequency range. It is widely used in the fields of electronics, communication and signal processing. With rapid development of modern communication technology, requirements of integration, low power consumption and multifunction are getting higher and higher, and realization of integrated and low-cost filter design is a demand for development.

### SUMMARY

The following is a summary of subject matter described herein in detail. This summary is not intended to limit the protection scope of the claims.

The present disclosure provides a microstrip filter, an electronic device and an indoor distribution system.

In one aspect, an embodiment provides a microstrip filter including a first substrate and a second substrate disposed oppositely, and a dielectric layer disposed between the first substrate and the second substrate. The first substrate includes a first base substrate and a patch array disposed on a side of the first base substrate close to the dielectric layer. The second substrate includes a second base substrate, a microstrip line disposed on a side of the second base substrate close to the dielectric layer, and a ground layer disposed on a side of the second base substrate away from the microstrip line; wherein the microstrip line includes a main transmission line and at least one branch. An orthographic projection of the at least one branch of the microstrip line on the first base substrate overlaps with an orthographic projection of the patch array on the first base substrate, and the dielectric layer is configured to adjust a resonant frequency between the patch array and the microstrip line when a voltage is applied to a patch of the patch array.

In some exemplary embodiments, the microstrip line includes a plurality of branches disposed symmetrically with respect to the main transmission line.

In some exemplary embodiments, the microstrip line includes eight branches disposed symmetrically with respect to the main transmission line.

In some exemplary embodiments, the microstrip line includes a plurality of branches, and the plurality of branches are connected on a same side of the main transmission line.

In some exemplary embodiments, the microstrip line includes four branches, and the four branches are connected on the same side of the main transmission line.

In some exemplary embodiments, an extension direction of a branch of the microstrip line is perpendicular to an extension direction of the main transmission line.

In some exemplary embodiments, the patch array includes a plurality of types of patches, and patches of a same type have a same shape and size; and one type of patches corresponds to one tunable center frequency.

In some exemplary embodiments, the orthographic projection of the at least one branch of the microstrip line on the first base substrate overlaps with all of orthographic projections of a plurality of patches of the patch array on the first base substrate, and the plurality of patches overlapped with the same branch are of different types.

In some exemplary embodiments, the plurality of patches overlapped with an orthographic projection of the same branch on the first base substrate are arranged in order of size from small to large in a direction away from the main transmission line.

In some exemplary embodiments, at least one type of patches each has a slotted region, and an orthographic projection of the slotted region on the first base substrate overlaps with an orthographic projection of a branch of the microstrip line on the first base substrate.

In some exemplary embodiments, the orthographic projection of the slotted region on the first base substrate is rectangular.

In some exemplary embodiments, orthographic projections of at least one type of patches on the first base substrate are rectangular.

In some exemplary embodiments, the first substrate further includes a plurality of drive electrode lines disposed on the first base substrate, and a plurality of patches of a same type are connected to a same drive electrode line.

In some exemplary embodiments, the first substrate further includes a first alignment layer on a side of the patch array close to the dielectric layer; and the second substrate further includes a second alignment layer on a side of the microstrip line close to the dielectric layer.

In some exemplary embodiments, the dielectric layer includes a liquid crystal layer.

On the other hand, an embodiment provides a driving method of the microstrip filter as previously described, including applying a voltage to at least one patch in the patch array to change a dielectric constant of the dielectric layer between the at least one patch and a branch so as to control a resonant frequency between the at least one patch and the microstrip line.

In another aspect, an embodiment provides an electronic device including the microstrip filter as previously described.

In another aspect, an embodiment provides an indoor distribution system including the microstrip filter as previously described.

In some exemplary embodiments, the indoor distribution system includes an indoor distribution source module, an intermediate module, and an indoor distribution antenna module. The intermediate module is connected between the indoor distribution source module and the indoor distribution antenna module. The indoor distribution antenna module includes a filter mixing unit and a plurality of antennas, the filter mixing unit is connected to the intermediate module and the plurality of antennas, and the filter mixing unit includes at least one microstrip filter.

Other aspects of the present disclosure may be comprehended after the drawings and the detailed descriptions are read and understood.

### BRIEF DESCRIPTION OF DRAWINGS

Accompanying drawings are used for providing further understanding of technical solutions of the present disclosure, constitute a part of the specification, and are used for explaining the technical solutions of the present disclosure together with embodiments of the present disclosure, but do not constitute limitations on the technical solutions of the present disclosure.

FIG. 1 is a schematic structural diagram of a microstrip filter according to at least one embodiment of the present disclosure.

FIG. 2 is a schematic partial cross-sectional view along a Q-Q′ direction in FIG. 1.

FIG. 3 is a plan schematic diagram of a first substrate according to at least one embodiment of the present disclosure.

FIG. 4 is a plan schematic diagram of a second substrate according to at least one embodiment of the present disclosure.

FIG. 5A and FIG. 5B are schematic diagrams of simulation results of a microstrip filter according to at least one embodiment of the present disclosure.

FIG. 6 is another schematic diagram of a microstrip filter according to at least one embodiment of the present disclosure.

FIG. 7 is another schematic diagram of a microstrip filter according to at least one embodiment of the present disclosure.

FIG. 8 is another schematic diagram of a microstrip filter according to at least one embodiment of the present disclosure.

FIG. 9 is a schematic structural diagram of an indoor distribution system according to at least one embodiment of the present disclosure.

FIG. 10 is a schematic diagram of an indoor distribution source module of at least one embodiment of the present disclosure.

FIG. 11 is another schematic diagram of an indoor distribution source module of at least one embodiment of the present disclosure.

FIG. 12 is a schematic diagram of a filter mixing unit of an indoor distribution antenna module according to at least one embodiment of the present disclosure.

FIG. 13 is another schematic diagram of a filter mixing unit of an indoor distribution antenna module according to at least one embodiment of the present disclosure.

FIG. 14 is a schematic diagram of an electronic device according to at least one embodiment of the present disclosure.

### DETAILED DESCRIPTION

Embodiments of the present disclosure will be described in detail hereinafter with reference to the drawings. Implementation modes may be implemented in a plurality of different forms. Those of ordinary skills in the art may easily understand such a fact that implementation modes and contents may be transformed into one or more forms without departing from the purpose and scope of the present disclosure. Therefore, the present disclosure should not be construed as being limited to the contents recorded in the following implementation modes only. The embodiments in the present disclosure and features in the embodiments may be randomly combined with each other if there is no conflict.

In the drawings, a size of one or more constituent elements, a thickness of a layer, or a region is sometimes exaggerated for clarity. Therefore, one implementation mode of the present disclosure is not necessarily limited to the dimensions, and shapes and sizes of a plurality of components in the accompanying drawings do not reflect actual scales. In addition, the accompanying drawings schematically illustrate ideal examples, and one implementation mode of the present disclosure is not limited to shapes, numerical values, or the like shown in the drawings.

Ordinal numerals such as “first”, “second” and “third” in the present disclosure are set to avoid confusion between constituent elements, but not intended for restriction in quantity. “A plurality of” in the present disclosure means a quantity of two or more.

In the present disclosure, for convenience, wordings indicating orientation or positional relationship such as “middle”, “upper”, “lower”, “front”, “rear”, “vertical”, “horizontal”, “top”, “bottom”, “inner” and “outer” are employed to explain positional relationship between the constituent elements with reference to the accompanying drawings, they are employed for ease of description and simplification of the description only, but do not indicate or imply that the referred device or element must have a particular orientation, be constructed and operate in a particular orientation, and therefore cannot be construed as limitations on the present disclosure. The positional relationships between the constituent elements are changed as appropriate based on directions according to which the constituent elements are described. Therefore, appropriate replacements based on situations are allowed, which are not limited to the wordings in the specification.

In the present disclosure, the terms “mounted”, “connected” and “connection” are to be understood broadly, unless otherwise expressly specified and defined. For example, a connection may be fixed connection, or detachable connection, or integral connection; it may be mechanical connection or electrical connection; it may be direct connection, or indirect connection through an intermediate, or internal communication between two elements. Those of ordinary skills in the art may understand meanings of the aforementioned terms in the present disclosure according to situations.

In the present disclosure, “electric connection” includes a case where constituent elements are connected through an element with a certain electrical effect. The “element with the certain electrical effect” is not particularly limited as long as electrical signals between the connected constituent elements may be transmitted. Examples of the “element with the certain electrical effect” not only include electrodes and wirings, but also include switching elements such as transistors, resistors, inductors, capacitors, other elements with one or more functions, etc.

In the present disclosure, “parallel” refers to a state in which an angle formed by two straight lines is above −10° and below 10°, and thus may include a state in which the angle is above −5° and below 5°. In addition, “perpendicular” refers to a state in which an angle formed by two straight lines is above 80° and below 100°, and thus may include a state in which the angle is above 85° and below 95°.

In the present disclosure, “about” and “approximately” refers to that a boundary is defined not so strictly and numerical values within process and measurement error ranges are allowed. In the present disclosure, “identical” may include cases of being exactly identical and substantially identical, and “substantially identical” is cases where values differ by less than 10%

The present disclosure provides a microstrip filter, an electronic device and an indoor distribution system, which may implement integrated and low-cost filter design.

An embodiment provides a microstrip filter, including a first substrate and a second substrate disposed oppositely, and a dielectric layer disposed between the first substrate and the second substrate. The first substrate includes a first base substrate and a patch array disposed on a side of the first base substrate close to the dielectric layer. The second substrate includes a second base substrate, a microstrip line disposed on a side of the second base substrate close to the dielectric layer, and a ground layer disposed on a side of the second base substrate away from the microstrip line. The microstrip line includes a main transmission line and at least one branch. An orthographic projection of the branch of the microstrip line on the first base substrate overlaps with an orthographic projection of the patch array on the first base substrate. The dielectric layer is configured to adjust a resonant frequency between the patch array and the microstrip line when a voltage is applied to patches of the patch array.

By setting that the orthographic projection of the branch of the microstrip line on the first base substrate overlaps with the orthographic projection of the patch array on the first base substrate, and by applying a voltage to the patches of the patch array to change a dielectric constant of the dielectric layer, the microstrip filter provided by this embodiment controls the resonant frequency between the patch and the branch of the microstrip line whose orthographic projections overlap, thereby achieving a band-pass effect of allowing a signal of a corresponding frequency to pass.

In some exemplary embodiments, the dielectric layer may include a liquid crystal layer. When the dielectric layer includes a liquid crystal layer, a dielectric constant of the liquid crystal material may be adjusted at different voltages to control a frequency response between the patches of the patch array and the microstrip line. In some other examples, the dielectric layer may include at least one of a lead zirconate titanate (PZT) thin film, a calcium barium zirconate titanate (BZT) thin film, a barium strontium titanate (BST) thin film, and the like, and this embodiment is not limited thereto.

In some exemplary embodiments, the microstrip line may include a plurality of branches, and the plurality of branches may be disposed symmetrically with respect to the main transmission line. For example, the microstrip line may include eight branches, and the eight branches may be arranged symmetrically with respect to the main transmission line. In this example, the branches are arranged symmetrically so that radiation characteristics generated between the branches on two sides of the main transmission line and the patch array may counteract with each other, thus avoiding leakage of radiation of electromagnetic waves and avoiding interference to external devices.

In some exemplary embodiments, the microstrip line may include a plurality of branches and the plurality of branches may be connected on a same side of the main transmission line. For example, the microstrip line may include four branches, and the four branches may be connected on a same side of the main transmission line. In this example, the branches are arranged asymmetrically, which may limit radiation of electromagnetic waves while ensuring that a distance between the patch array and a ground layer is close enough and thicknesses of the first base substrate and the second base substrate are small (for example, much less than 1/10 wavelength).

In some exemplary embodiments, the patch array may include a plurality of types of patches and the patches of a same type may have same shape and size. A quantity of patch types corresponds to a quantity of tunable center frequencies of the microstrip filter. In this example, patches of a same type may correspond to a same tunable center frequency. By providing a plurality of types of patches, this example may support the microstrip filter to achieve different frequency responses, and the resonant frequency between the patches and the microstrip line is controlled by applying a voltage to one or more types of patches to achieve a required filter effect.

In some exemplary embodiments, an orthographic projection of at least one branch of the microstrip line on the first base substrate may overlap with an orthographic projection of a plurality of patches of the patch array on the first base substrate, and the plurality of patches overlapped with the same branch are of different types. In some examples, the plurality of patches overlapped with the orthographic projection of the same branch on the first base substrate may be arranged in order of size in a direction away from the main transmission line. The arrangement mode of the patch array in this example may be beneficial to ensuring the effect of the microstrip filter.

In some exemplary embodiments, at least one type of patches may each have a slotted region. An orthographic projection of the slotted region on the first base substrate may overlap with an orthographic projection of a branch of the microstrip line on the first base substrate. In some examples, the orthographic projection of the slotted region on the first base substrate may be rectangular. For example, the orthographic projections of at least one type of patches on the first base substrate may each be a rectangular ring. By providing a slotted region on the patch in this example, a radiation side length of the patch overlapped with the branch may be increased, which is beneficial to reducing a size of the patch array.

In some exemplary embodiments, the first substrate may further include a plurality of drive electrode lines disposed on the first base substrate, and a plurality of patches of a same type are connected to a same drive electrode line. Since whether a voltage is applied to a patch will affect the on/off of a corresponding frequency, by controlling the same type of patches with a same drive voltage, in this example, a frequency band of response frequency may be narrower and a better on/off effect may be achieved, however, this embodiment is not limited thereto. In some other examples, the plurality of patches of the same type may be connected to different drive electrode lines. Partition isolation degree may be easily weakened by applying different voltages to the patches of the same type.

Solutions of the embodiments will be described below through some examples.

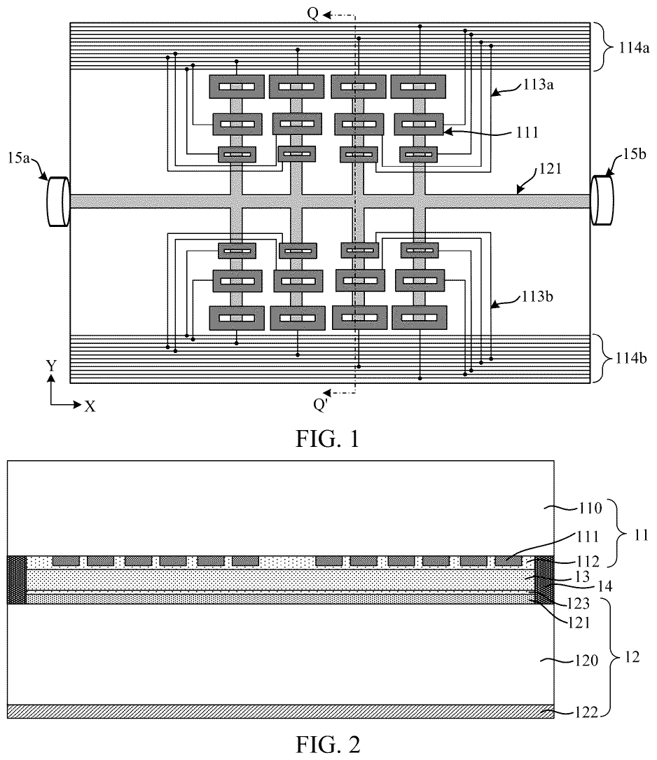

FIG. 1 is a schematic structural diagram of a microstrip filter according to at least one embodiment of the present disclosure. FIG. 2 is a schematic partial cross-sectional view along a Q-Q′ direction in FIG. 1. In some examples, as shown in FIGS. 1 and 2, the microstrip filter of this example may include a first substrate 11 and a second substrate 12 disposed oppositely, and a dielectric layer 13 disposed between the first substrate 11 and the second substrate 12. In some examples, the dielectric layer 13 may be a liquid crystal layer including a liquid crystal material. The first substrate 11 and the second substrate 12 may be cell-aligned to form a liquid crystal cell and the dielectric layer 13 may be disposed in the liquid crystal cell, however, this embodiment is not limited thereto. In some other examples, the dielectric layer may include at least one of a lead zirconate titanate (PZT) thin film, a calcium barium zirconate titanate (BZT) thin film, a barium strontium titanate (BST) thin film, and the like.

In some examples, as shown in FIG. 2, a support structure 14 may be disposed between the first substrate 11 and the second substrate 12. The support structure 14 may be generally an annular structure around perimeters of the first substrate 11 and the second substrate 12. The support structure 14 may include an encapsulation glue and a spacer (also referred to as a spacer post). By providing the support structure, a cavity may be formed between the first substrate 11 and the second substrate 12, and the liquid crystal layer between the first substrate 11 and the second substrate 12 may be formed by injecting a liquid crystal material into the cavity, however, this embodiment is not limited thereto. In this example, by providing the support structure, a gap between the first substrate and the second substrate may be maintained, which is beneficial to maintaining uniformity of the liquid crystal layer and prevent cavity collapse from affecting thickness uniformity of the liquid crystal layer.

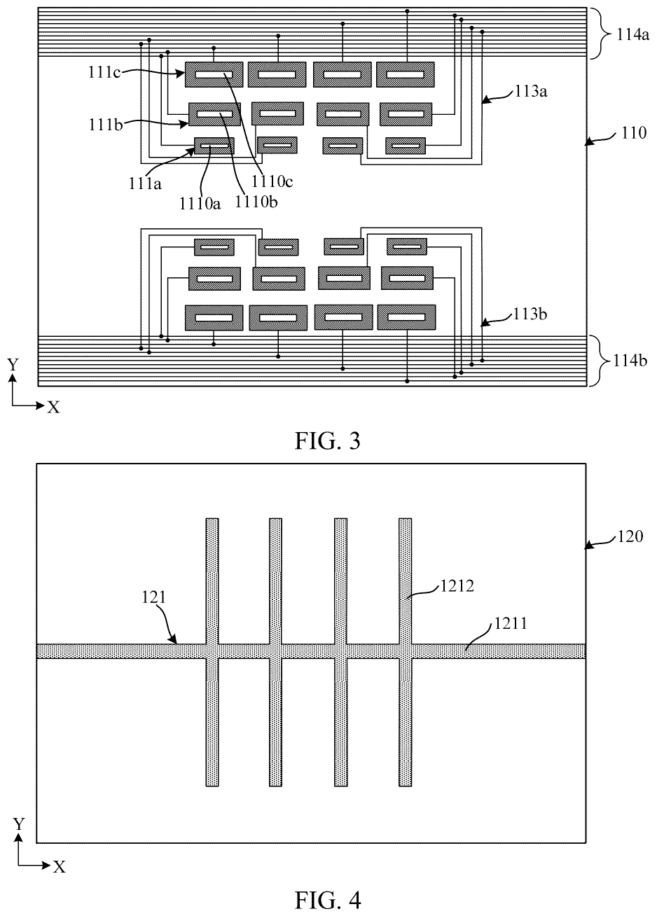

FIG. 3 is a plan schematic diagram of a first substrate according to at least one embodiment of the present disclosure. In some examples, as shown in FIGS. 1 to 3, the first substrate 11 may include a first base substrate 110 and a patch array disposed on the first base substrate 110. The patch array may be on a side of the first base substrate 110 close to the dielectric layer 13. The patch array may include a plurality of patches 111 arranged in an array. A plurality of patches 111 arranged in a first direction X may be referred to as one row of patches and a plurality of patches 111 arranged in a second direction Y may be referred to as a column of patches. The first direction X intersects with the second direction Y. For example, the first direction X may be perpendicular to the second direction Y.

In some examples, as shown in FIG. 3, the first substrate 11 may further include a plurality of drive electrode lines 113a and 113b on the first base substrate 110. The plurality of patches 111 of the patch array may be electrically connected to the plurality of drive electrode lines. For example, the plurality of patches 111 and the plurality of drive electrode lines 113a and 113b may be electrically connected in one-to-one correspondence. For example, a patch 111 and the drive electrode line connected thereto may be of an interconnected integral structure.

In some examples, as shown in FIG. 3, the first substrate 11 may further include a plurality of drive transmission lines 114a and 114b on the first base substrate 110 and extending in the first direction X. A plurality of drive transmission lines 114a and 114b may be arranged in edge regions on two sides of the patch array in the second direction Y. The plurality of drive transmission lines 114a and the plurality of drive electrode lines 113a may be electrically connected to each other, and the plurality of drive transmission lines 114b and the plurality of drive electrode lines 113b may be electrically connected to each other. For example, the plurality of drive electrode lines and the plurality of drive transmission lines may be electrically connected in one-to-one correspondence. The drive transmission lines 114a and 114b may be configured to receive a voltage signal transmitted by an external controller. Each drive transmission line and the connected drive electrode line may be of an interconnected integral structure, however, this embodiment is not limited thereto. In some other examples, the drive transmission lines may be omitted, and the drive electrode lines may extend directly outward and receive the voltage signal transmitted by the controller.

In some examples, the patch array may include a plurality of types of patches. The patches of the same type may have same shape and size, and at least one of sizes and shapes of different types of patches may be different. For example, different types of patches have the same shape but different sizes, or different types of patches have different shapes and different sizes. One type of patches may correspond to one resonant center frequency. A quantity of patch types corresponds to a quantity of resonant center frequencies. Different types of patches correspond to different resonant center frequencies. This example is illustrated by taking three types of patches (e.g., the first type of patches 111a, the second type of patches 111b and the third type of patches 111c shown in FIG. 3) as examples. The microstrip filter of this example may correspond to three resonant center frequencies.

In some examples, the patches of each type may each have a slotted region. For example, the first type of patches 111a may each have a first slotted region 1110a, the second type of patches 111b may each have a second slotted region 1110b, and the third type of patches 111c may each have a third slotted region 1110c. Orthographic projections of the first slotted region 1110a, the second slotted region 1110b, and the third slotted region 1110c on the first base substrate 110 may all be substantially rectangular. Sizes of the first slotted region 1110a, the second slotted region 1110b, and the third slotted region 1110c may be sequentially larger.

In some examples, as shown in FIG. 3, shapes of the orthographic projections of the first type of patches 111a, the second of patches 111b, and the third type of patches 111c on the first base substrate 1110 may all be rectangular rings, sizes of the first type of patch 111a may be smaller than a size of a second type of patch 111b, and sizes of second type of patches 111b may be smaller than sizes of the third type of patches 111c.

FIG. 4 is a plan schematic diagram of a second substrate according to at least one embodiment of the present disclosure. In some examples, as shown in FIGS. 1-4, the second substrate 12 may include a second base substrate 120, and a microstrip line 121 and a ground layer 122 respectively disposed on opposite sides of the second base substrate 120. The microstrip line 121 may be on a side of the second base substrate 120 close to the dielectric layer 13, and the ground layer 122 may be on a side of the second base substrate 120 away from the dielectric layer 13. The ground layer 122 may be an entire metal layer, and an orthographic projection of the ground layer 122 on the second base substrate 120 may cover an orthographic projection of the microstrip line 121 on the second base substrate 120. In this example, a microstrip transmission structure may be formed using the microstrip line 121, the second base substrate 120 and the ground layer 122.

In some examples, as shown in FIG. 4, the microstrip line 121 may include a main transmission line 1211 and at least one branch 1212. A shape of an orthographic projection of the main transmission line 1211 on the second base substrate 120 may be a strip extending in the first direction X. One end of the main transmission line 1211 may be connected to a first port 15a and the other end of the main transmission line 1211 may be connected to a second port 15b. The first port 15a and the second port 15b may be an input port and an output port of the microstrip filter respectively. Types and arrangement modes of the first port and the second port are not limited in this embodiment.

In some examples, the microstrip line 121 may include a plurality of branches 1212, such as eight branches 1212. The plurality of branches 1212 and the main transmission line 1211 may be interconnected to form an integral structure. A shape of an orthographic projection of a single branch 1212 on the second base substrate 120 may be substantially a strip extending in the second direction Y. An extension direction of the branch 1212 may be perpendicular to an extension direction of the main transmission line 1211. The eight branches 1212 of this example may be disposed symmetrically with respect to the main transmission line 1211. The eight branches 1212 may have approximately the same size. Spacings between adjacent branches 1212 may be substantially the same. The microstrip line 121 may be substantially symmetrical with respect to a centerline in the first direction X and may also be substantially symmetrical with respect to a centerline in the second direction Y. In this example, the branches of the microstrip line may be symmetrically arranged. Because of the symmetrical design of both sides, surface currents of the patch array may have opposite directions, so that the generated radiation characteristics counteract with each other, thus avoiding interference to external devices.

In some examples, an orthographic projection of each branch 1212 of the microstrip line 121 on the first base substrate 110 may overlap with an orthographic projection of the patch array on the first base substrate 110, and an orthographic projection of the main transmission line 1211 on the first base substrate 110 and the orthographic projection of the patch array on the first base substrate 110 may not overlap. The patch array may be disposed substantially symmetrically with respect to the main transmission line 1211. The patch array in this example may be arranged in six rows and four columns. The main transmission line 1211 may be provided with three rows and four columns on one side of the second direction Y and three rows and four columns on the opposite side of the second direction Y. A plurality of patches in a same row have a same size, and belong to a same type, and a plurality of patches in a same column may have different sizes, and belong to different types.

In some examples, an orthographic projection of each branch 1212 on the first base substrate 110 overlaps with all of orthographic projections of a column of patches (including three different types of patches, i.e., a first type of patch 111a, a second type of patch 111b, and a third type of patch 111c) on the first base substrate 110. Three patches that overlap with the orthographic projection of each branch 1212 on the first base substrate 110 may be arranged in order of size from small to large in a direction away from the main transmission line 1211. The first type of patch 111a, the second type of patch 111b, and the third type of patch 111c, which are in the same column, may be aligned in the second direction Y, and the three types of patches may overlap along a centerline of the first direction X. Centerlines of the three patches in the first direction X may substantially overlap with the centerline of the overlapped branch 1212 in the first direction X, however, this embodiment is not limited thereto. In some other examples, a column of patches overlapped with the orthographic projection of the branches on the first base substrate may be arranged in order of size from large to small in the direction away from the main transmission line. In some other examples, the plurality of patches of the patch array may be disposed in a nested manner. For example, a first type of patch may be disposed within a second slotted region of a second type of patch, or a second type of patch may be disposed within a third slotted region of a third type of patch.

In some examples, as shown in FIG. 2, the first substrate 11 may further include a first alignment layer 112 on a side of the patch array close to the dielectric layer 13. The second substrate 12 may further include a second alignment layer 123 on a side of the microstrip line 121 close to the dielectric layer 13. In this example, by providing the first alignment layer and the second alignment layer, liquid crystal molecules in the dielectric layer may be aligned so as to be arranged in a certain direction.

In some examples, the microstrip filter of this example employs a double-sided metal process on the second substrate to form a microstrip transmission structure. As an anisotropic material, the liquid crystal molecules in the liquid crystal layer have different dielectric constants along long axes and short axes thereof. After a deflection voltage is applied to both ends of the liquid crystal molecules, the liquid crystal molecules will deflect, and a dielectric constant of the liquid crystal materials will be changed with the deflection of the liquid crystal. By applying a voltage to the patches of the patch array, a resonant frequency between the patches and the overlapped microstrip transmission structure may be adjusted by using the deflection of the liquid crystal. The dielectric constant of the liquid crystal molecules in the liquid crystal layer corresponding to each patch and microstrip transmission structure may be independently controlled and changed. When a voltage is applied to a corresponding patch by a drive electrode line, the deflection of the liquid crystal may be used to achieve resonance of the patches and the overlapped microstrip transmission structure at a non-center frequency, so that a center frequency signal corresponding to the patch may pass and form a band-pass effect. When the voltage is not applied to the patch by the drive electrode line, the patch and the overlapped microstrip transmission structure generate resonance at the center frequency, so that the center frequency signal corresponding to the patch is cut off to form a band-stop effect. The liquid crystal layer of this example is configured to control on and off of the resonant center frequency corresponding to the patch. In some examples, a quantity of patch types may determine a quantity of tunable center frequencies of the microstrip filter. One type of patches corresponds to one tunable center frequency, and different types of patches may correspond to different center frequencies. In some examples, a quantity of branches of the microstrip line may determine a bandwidth corresponding to the tunable center frequency. The more branches of the microstrip line, the larger the quantity of patches of a same type overlapping with the branches, which is beneficial to increasing a bandwidth corresponding to the center frequency corresponding to this type of patches and improve the filtering effect. The fewer branches of the microstrip line, the smaller the quantity of patches of the same type overlapping with the branches, so that the bandwidth corresponding to the center frequency corresponding to this type of patches decreases.

In some examples, a drive voltage applied to the patches of the patch array may depend on a material and a thickness of the dielectric layer. The drive voltage may be less than 30V. For example, the dielectric layer may be a liquid crystal layer, and the drive voltage may be less than or equal to 8V.

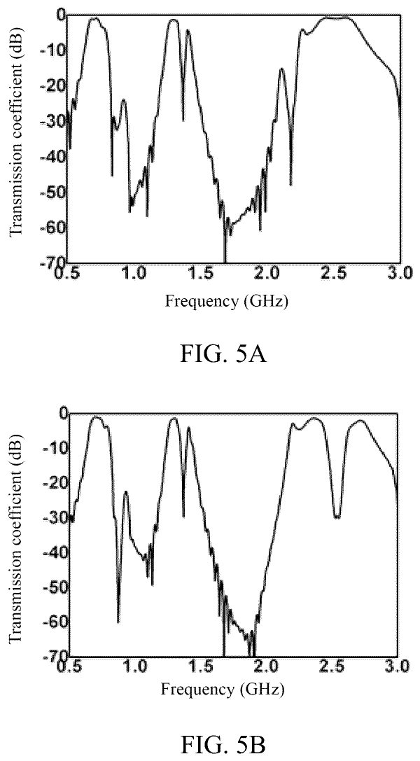

FIG. 5A and FIG. 5B are schematic diagrams of simulation results of a microstrip filter according to at least one embodiment of the present disclosure. FIG. 5A shows a simulation result after applying a voltage to a first type of patch of the patch array of the microstrip filter shown in FIG. 1. FIG. 5B shows a simulation result when no voltage is applied to the first type of patch of the patch array of the microstrip filter shown in FIG. 1.

In some examples, the first type of patch may have a length of 10.5 mm and a width of 5 mm. The first slotted region of the first type of patch may have a length of 6.4 mm and a width of 0.8 mm. The first type of patch may correspond to 2.5 GHz to 2.6 GHz. The second type of patch may have a length of 23 mm and a width of 8 mm. The second slotted region of the second type of patch may have a length of 10 mm and a width of 0.8 mm. The second type of patch may correspond to 0.74 GHz to 0.76 GHz. The third type of patch may have a length of 23 mm and a width of 10 mm. The third slotted region of the third type of patch may have a length of 20 mm and a width of 0.8 mm. The third type of patch may correspond to 1.34 GHz to 1.38 GHz. A width of the main transmission line of the microstrip line (i.e., a length in the second direction Y) may be about 1.6 mm, a width of a branch (i.e., a length in the first direction X) may be about 4 mm, a length of the branch (i.e., a length in the second direction Y) may be about 72 mm, and a spacing between adjacent branches may be about 28 mm. A thickness of the liquid crystal layer may be about 20 microns (um).

In some examples, FIG. 5A and FIG. 5B illustrate comparatively whether 2.5 GHz to 2.6 GHz is passable. FIG. 5A shows a case where the first type of patch is applied with a voltage and the second type of patch and the third type of patch are not applied with a voltage, and FIG. 5B shows a case where none of the first type of patch, the second type of patch and the third type of patch is applied with a voltage. As can be seen from FIG. 5A, when a voltage is applied to the first type of patch, a signal from 2.5 GHz to 2.6 GHz can pass through, thus achieving a band-pass effect. As can be seen from FIG. 5B, when the voltage applied to the first type of patch is removed, the loss from 2.5 GHz to 2.6 GHz reaches 30 dB, which is equivalent to that the signal does not pass through this portion, thus achieving a band-stop effect. In this example, a purpose of signal on-off may be achieved by controlling application of a voltage to the corresponding type of patch. In some examples, quantity of patch types may be reasonably designed according to the quantity of frequencies to be reused.

The following is an exemplary description by a preparation process of a microstrip filter. A “patterning process” mentioned in the present disclosure includes photoresist coating, mask exposure, development, etching, photoresist stripping, etc., for a metal material, an inorganic material, or a transparent conductive material, and includes organic material coating, mask exposure, development, etc., for an organic material. Deposition may be any one or more of sputtering, evaporation, and chemical vapor deposition, coating may be any one or more of spray coating, spin coating, and inkjet printing, and etching may be any one or more of dry etching and wet etching, the present disclosure is not limited thereto. A “thin film” refers to a layer of thin film made of a certain material on a base substrate using deposition, coating, or other processes. If the “thin film” does not need to be processed through a patterning process in the entire manufacturing process, the “thin film” may also be called a “layer”. If the “thin film” needs to be processed through the patterning process in the entire manufacturing process, the “thin film” is called a “thin film” before the patterning process is performed and is called a “layer” after the patterning process is performed. At least one “pattern” is contained in the “layer” which has been processed through the patterning process.

In the present disclosure, “A and B are disposed in a same layer” means that A and B are formed simultaneously through a same one-time patterning process. In an exemplary embodiment of the present disclosure, “an orthographic projection of A includes an orthographic projection of B” refers to that a boundary of the orthographic projection of B falls within a range of a boundary of the orthographic projection of A, or the boundary of the orthographic projection of A coincides with the boundary of the orthographic projection of B.

In some exemplary embodiments, a preparation process of a microstrip filter may include the following operations.
(1) A first substrate is prepared. In some examples, a trace layer and a first conductive layer are sequentially formed on a first base substrate. For example, a trace thin film is coated on a first base substrate to form a trace layer by a patterning process; and subsequently, a first conductive thin film is coated to form a first conductive layer. The first conductive layer may be made of a metal material having good conductivity, such as copper (Cu) or the like. The first conductive layer may include a patch array. The trace layer may be made of a metal material or a transparent conductive material, such as indium tin oxide (ITO). The trace layer may include a plurality of drive electrode lines, or a plurality of drive electrode lines and a plurality of drive transmission lines.

In some examples, a first alignment film may be coated on the first base substrate on which the foregoing pattern is formed, the first alignment film is cured, and alignment is performed on the cured first alignment film by using an alignment technology, to obtain a transparent first alignment layer. The first alignment layer may cover the first conductive layer and the trace layer.
(2) A second substrate is prepared. In some examples, a second conductive layer and a ground layer are respectively formed on opposite sides of the second base substrate. The second conductive layer may be made of a metal material having good conductivity, such as copper (Cu) or the like. The second conductive layer may include a microstrip line. A ground layer may be formed by coating on a side of the second base substrate away from the second conductive layer. An orthographic projection of the ground layer on the second base substrate may include an orthographic projection of the second conductive layer on the second base substrate.

In some examples, a second alignment film may be coated on the second base substrate on which the foregoing patterns are formed, the second alignment film is cured, and alignment is performed on the cured second alignment film by using an alignment technology, to obtain a transparent second alignment layer. The second alignment layer may cover the second conductive layer.

In some examples, the alignment technology may include: a friction alignment technology and an ultraviolet light alignment technology. A groove may be formed on a surface of the first alignment layer by the alignment technology, and is used for performing alignment on liquid crystal molecules, so that the liquid crystal molecules are arranged along a certain direction. A material of the first alignment film may be polyimide, polyamide, polyethylene, polystyrene, or polyvinyl alcohol. However, this embodiment is not limited thereto.

In some examples, the first base substrate and the second base substrate may be rigid base substrates, such as glass substrates. By using rigid base substrate to form a liquid crystal cell, a thickness of the liquid crystal cell may be accurately controlled and thickness uniformity of the liquid crystal cell may be ensured. Moreover, a microstrip filter based on glass base substrates is convenient for mass production, which is beneficial to reducing complexity and cost of devices.
(3) The first substrate and the second substrate are cell-aligned to prepare a liquid crystal cell.

In some examples, an encapsulation glue is coated on a periphery of the first substrate or the second substrate, the first substrate and the second substrate are cell-aligned, and a support structure is formed between the first substrate and the second substrate by curing the encapsulation glue. A cavity is formed by the first substrate, the second substrate and the support structure. A plurality of crystal injection ports may be provided on the support structure in turn, and a liquid crystal material is injected through the crystal injection ports to form a liquid crystal layer as a dielectric layer.

In this example, the branches and patches of the microstrip line may form upper and lower electrodes for controlling operation of the liquid crystal layer, and a resonant frequency of the filter may be easily adjusted by using the electrically tunable dielectric characteristics of the liquid crystal material itself. When adjusting the resonant frequency of the filter, a drive voltage may be applied through the patches, which causes a voltage difference between the patches and the branches and changes arrangement of liquid crystal molecules, thus achieving the effect of adjusting the resonant frequency.

According to the microstrip filter provided in this example, a plurality of adjustable units with adjustable resonant frequency may be designed on a glass substrate using a semiconductor thin film technology (i.e., a structure with a liquid crystal layer sandwiched between patches and branches), and the resonant frequency of each adjustable unit is controlled by applying a voltage, to implement different frequency responses of the same adjustable unit, thus achieving the filter effect by combined control of a plurality of adjustable units. Since the adjustable unit in this example may control different frequency responses through application of a voltage, different filter effects may be controlled and achieved through application of different voltages in combination, so that the purpose of simplifying design and reducing cost may be achieved.

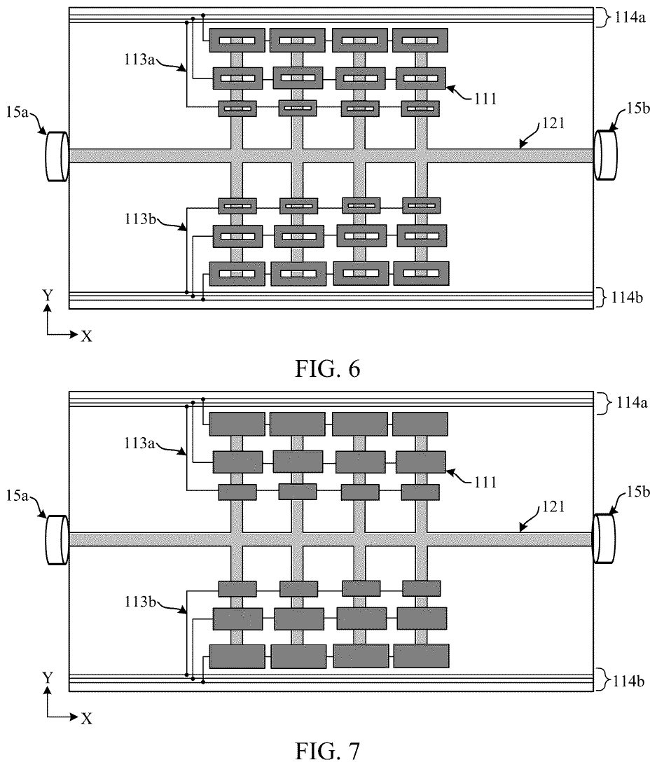

FIG. 6 is another schematic diagram of a microstrip filter according to at least one embodiment of the present disclosure. In some examples, as shown in FIG. 6, the patch array may be disposed symmetrically with respect to the main transmission line of the microstrip line 121, and in the patch array on one side of the main transmission line, the patches of the same type may be electrically connected to the same drive electrode line 113a or 113b. For example, a row of patches of a same type may be electrically connected to a same drive electrode line 113a or 113b. The remaining description of the microstrip filter of this example may refer to the description of the foregoing embodiments and is therefore not repeated herein.

In this example, since whether a voltage is applied or not will affect the on and off of the corresponding frequency, a frequency band of the response frequency may be narrowed by applying a same voltage to the same type of patches, thereby obtaining a better on-and-off effect, however, this embodiment is not limited thereto. In some other examples, the patches of the same type may be applied with different voltages to widen the band of response frequencies and weaken on and off isolation.

FIG. 7 is another schematic diagram of a microstrip filter according to at least one embodiment of the present disclosure. In some examples, as shown in FIG. 7, orthographic projections of patches 111 of the patch array on the first base substrate may be rectangular. The patch array of this example may include three types of patches whose orthographic projections on the base substrate may all be rectangular and of different sizes. The patches of the same type may be electrically connected to a same drive electrode line 113a or 113b. For example, a row of patches of a same type may be electrically connected to a same drive electrode line 113a or 113b. The remaining description of the microstrip filter of this example may refer to the description of the foregoing embodiments and is therefore not repeated herein.

In this example, in a case where an area of the microstrip filter is not limited, solid patches may be used to achieve the filter effect.

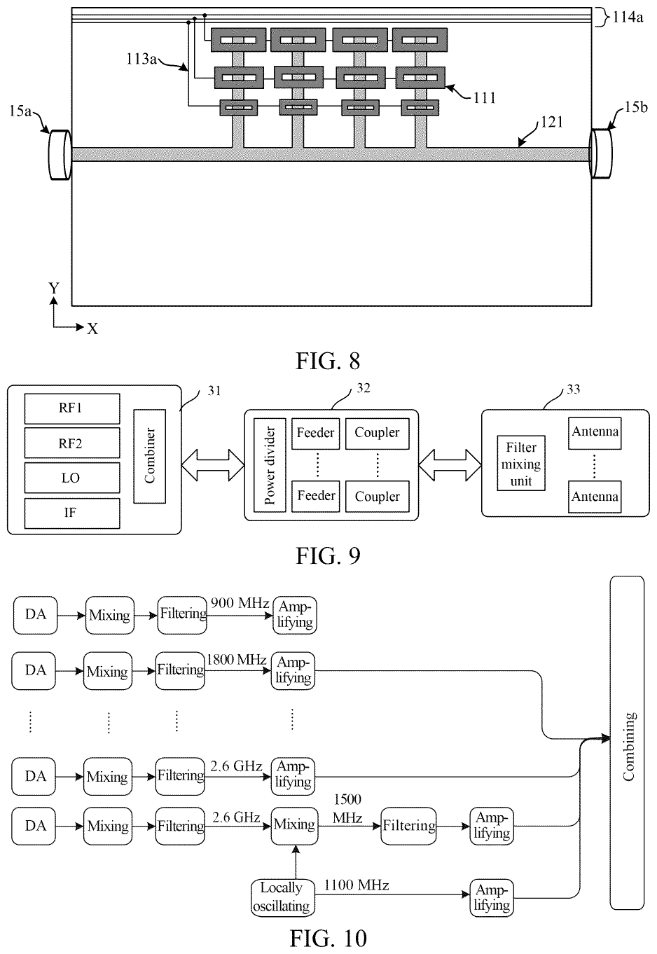

FIG. 8 is another schematic diagram of a microstrip filter according to at least one embodiment of the present disclosure. In some examples, as shown in FIG. 8, the microstrip line 121 may include four branches connected on the same side of the main transmission line. The patch array may include three rows and four columns. The remaining description of the microstrip filter of this example may refer to the description of the foregoing embodiments and is therefore not repeated herein.

In this example, the branches of the microstrip line may have an asymmetric structure with respect to the main transmission line, and the radiation of electromagnetic waves may be limited while ensuring that a distance between the patch array and the ground layer is sufficiently close and thicknesses of the first base substrate and the second base substrate are small (for example, much less than 1/10 wavelength).

The present disclosure further provides a driving method of the microstrip filter, which is applied to the microstrip filter as previously described. The driving method of this example may include applying a voltage to at least one patch in a patch array to change a dielectric constant of a dielectric layer between the at least one patch and a branch, so as to control a resonant frequency between the at least one patch and a microstrip line.

In some examples, the patch array includes a plurality of types of patches, and by applying a voltage to a plurality of patches of the same type, a signal corresponding to a resonant center frequency corresponding to such type of patches can pass, thereby achieving a bandpass effect. The desired filtering effect may be achieved through the combined control of whether a voltage is applied to the plurality of types of patches. The control unit (for example, provided with a control program) may supply a voltage signal to a corresponding patch by a drive electrode line, and control the resonant frequency by controlling the voltage applied to the corresponding patch, so as to achieve a desired filter effect.

The driving method of the microstrip filter according to this embodiment may refer to the description of the foregoing embodiment and is therefore not described here.

The present disclosure further provides an indoor distribution system including the microstrip filter as previously described.

In some examples, with the development and maturity of 5G technology, indoor users have more and more urgent requirements for high transmission with large bandwidth. The digital indoor distribution based on millimeter wave has not been commercialized due to technical and cost reasons, while traditional Distributed Antenna System (DAS), which is relatively mature, cannot carry higher data traffic. It has become a better scheme to recycle, capacity-expand and improve traditional DAS. Two mainstream technical routes are active frequency conversion DAS system and passive frequency conversion DAS system. Both technical routes achieve MIMO (Multiple Input Multiple Output) effect and implement capacity expansion by dividing and converting a 5G signal, converting it back after transmission, and distinguishing it from the original frequency through different polarization forms. However, any frequency conversion scheme will involve frequency conversion, matching and filter devices, usually using discrete devices, LTCC (Low Temperature Co-fired Ceramic), dielectric filters, etc., which will bring a series of problems such as customized design, high cost and large volume.

The indoor distribution system of this embodiment may adopt the microstrip filter provided by the previous embodiment. The resonant frequency may be controlled by applying a voltage, and the filter effect may be achieved by combined control of the patch to which a voltage is required to apply. Since the patch r to which the voltage is required may be controlled by a program to achieve different filter functions, the indoor distribution system of this embodiment may simplify complexity of system design and reduce the cost of system transformation by using the microstrip filter as previously described.

The following is an illustration of the indoor distribution system of this example.

FIG. 9 is a schematic structural diagram of an indoor distribution system according to at least one embodiment of the present disclosure. In some examples, as shown in FIG. 9, the indoor distribution system of this example may include an indoor distribution source module 31, an intermediate module 32, and an indoor distribution antenna module 33. The indoor distribution source module 31 may be configured to provide a wireless signal as an input to the system. For example, the wireless signal provided by the indoor distribution source module 31 may include a radio frequency signal RF1 (e.g., 900 MHz), a radio frequency signal RF2 (e.g., 1800 MHz/2 GHz/2.3 GHz/2.6 GHz), a local oscillator signal LO (e.g., 1100 MHz), and an intermediate frequency signal IF (e.g., 1500 MHz). Multiplex wireless signals may be combined by a combiner and then connected to the intermediate module 32 through a cable.

In some examples, after receiving the wireless signal provided by the indoor distribution source module 31 through the cable, the intermediate module 32 implements the coverage on the indoor area and capacity enhancement by amplifying, distributing and managing wireless signals. For example, the intermediate module 32 may include a power divider, a feeder, and a coupler.

In some examples, an output signal of the intermediate module 32 may be provided to the indoor distribution antenna module 33. The indoor distribution antenna module 33 may provide high-quality wireless signal coverage and transmission in an indoor environment. The indoor distribution antenna module 33 may include a filter mixing unit and a plurality of antennas. The filter mixing unit may be connected to the intermediate module 32 and the plurality of antennas. The filter mixing unit may filter and mix the output signal of the intermediate module 32 to obtain multiplex wireless signals, which are radiated through the plurality of antennas.

FIG. 10 is a schematic diagram of an indoor distribution source module of at least one embodiment of the present disclosure. In some examples, as shown in FIG. 10, after receiving the wireless signal, the radio frequency signal RF1 and the radio frequency signal RF2 in the multiplex wireless signal may undergo Digital to Analog (DA) conversion, mixing, filtering and amplification in sequence, and then combined by a combiner. The original 2.6 GHz signal in the source portion is divided into two signals, one of which is transmitted by 2.6 GHz carrier, and combined after digital-to-analog conversion, mixing, filtering and amplification, and the other undergoes digital-to-analog conversion, mixing, and filtering, and then is mixed with the local oscillator signal, to become an intermediate frequency signal, and the intermediate frequency signal is combined with other wireless signals after being filtered and amplified. The local oscillator signal is combined with other signals after being amplified. Processing units for local oscillation, mixing, filtering and amplification of the indoor distribution source module in this example may all be integrated in the source equipment, and then connected to the intermediate module through a cable after being combined by a combiner.

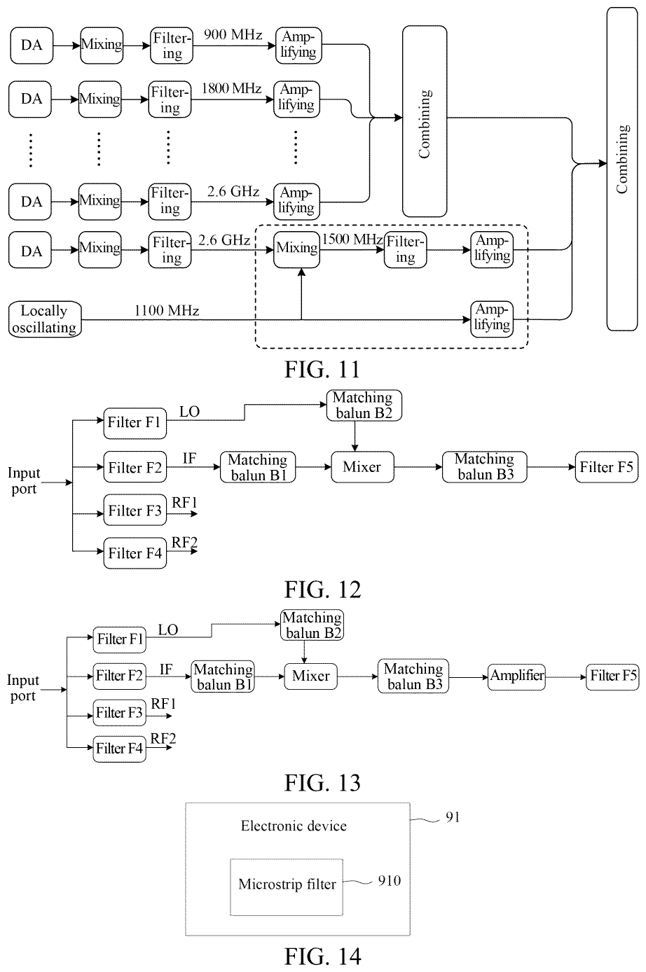

FIG. 11 is another schematic diagram of an indoor distribution source module of at least one embodiment of the present disclosure. In some examples, as shown in FIG. 11, the radio frequency signal RF1 and the radio frequency signal RF2 may be combined and transmitted through a first combiner after undergoing digital-to-analog conversion, mixing, filtering, and amplification in sequence. The original 2.6 GHz signal in the source portion may be divided into two signals. The first signal is transmitted by 2.6 GHz carrier and combined with other RF signals after digital-to-analog conversion, mixing, filtering and amplification. The signal of the second signal undergoes digital-to-analog conversion, mixing, and filtering, and then is mixed with the local oscillator signal, to become an intermediate frequency signal, and the intermediate frequency signal is combined with other wireless signals through a second combiner after being filtered and amplified. The processing units for mixing, filtering and amplification of the 2.6 GHz signal of the second signal may be encapsulated separately (such as the external unit indicated by the dashed box in FIG. 11) and externally connected to the source device integrated with other RF signals. In some examples, a filter within the external unit may employ the microstrip filter provided by the foregoing embodiments which may simplify the design and reduce the cost.

By dividing one 2.6 GHz signal of the source portion into two signals, one of which is still transmitted by 2.6 GHz carrier, and the other is transformed into an IF signal by a mixer and then is transmitted, the indoor distribution system of this example may ensure very low transformation cost without need of changing the intermediate system.

FIG. 12 is a schematic diagram of a filter mixing unit of an indoor distribution antenna module according to at least one embodiment of the present disclosure. In some examples, as shown in FIG. 12, an input port of the indoor distribution antenna module may receive an output signal from the intermediate module. After receiving the signal, the indoor distribution antenna module may obtain a local oscillator LO signal, an intermediate frequency signal IF, a radio frequency signal RF1 and a radio frequency signal RF2 by using a plurality of filters (for example, including filters F1, F2, F3 and F4). In the filter mixing unit, the intermediate frequency signal IF may be re-converted to 2.6 GHz. The output of the intermediate frequency signal IF through the matching balun B1 and the output of the oscillator signal LO through the matching balun B1 are mixed, and then the output of the mixer is processed by the matching balun B1 and the filter F5, so that a 2.6 GHz signal may be obtained. The antenna may adopt different polarized radiation to the 2.6 GHz signal in RF2 and the 2.6 GHz signal obtained by frequency conversion, so as to achieve a purpose of MIMO multi-stream.

In some examples, at least one of the filters F1, F2, F3, F4, and F5 in the filter mixing unit shown in FIG. 12 may employ a microstrip filter as described in the foregoing embodiment, and a patch to which a voltage is required to be applied in the microstrip filter may be controlled by program coding, and a voltage is applied to a corresponding patch to achieve different filtering effects.

In this example, all or part of the filters in the filter mixing unit in the indoor distribution system adopt the microstrip filter as described in the foregoing embodiment, and only by controlling filtering effect of the corresponding microstrip filter through different codes, the required filter types and device types may be reduced, thereby facilitating reducing design complexity and transformation cost.

FIG. 13 is another schematic diagram of a filter mixing unit of an indoor distribution antenna module according to at least one embodiment of the present disclosure. In some examples, as shown in FIG. 13, adding additional filters, mixers and other devices in the indoor distribution antenna module to convert the intermediate frequency signal will lead to additional attenuation of the intermediate frequency signal, resulting in imbalance of multi-input and multi-output signals. Therefore, an amplifier is added to amplify the converted signal after mixing the local oscillator signal LO with the intermediate frequency signal IF to ensure that levels of the two 2.6 GHz (original 2.6 GHz and the 2.6 GHz obtained by frequency conversion) signals are equal, however, this embodiment is not limited thereto. In some other examples, an attenuator may be added to attenuate the original 2.6 GHz signal to ensure that the levels of the two 2.6 GHz (original 2.6 GHz and the 2.6 GHz obtained by frequency conversion) signals are equal.

In some examples, at least one of the filters F1, F2, F3, F4, and F5 in the filter mixing unit shown in FIG. 13 may employ a microstrip filter as described in the foregoing embodiment, and a patch to which a voltage is required to be applied in the microstrip filter may be controlled by program coding, and a voltage is applied to a corresponding patch to achieve different filtering effects.

By adopting the microstrip filter as previously described, the indoor distribution system of this example may reduce the types of devices required by the whole system, which is beneficial to reducing the cost of system transformation, simplify the design and reduce the design complexity of the system.

FIG. 14 is a schematic diagram of an electronic device according to at least one embodiment of the present disclosure. As shown in FIG. 14, this embodiment provides an electronic device 91, including a microstrip filter 910 as described in the foregoing embodiment and a control unit. The control unit may control the resonant frequency between the corresponding patch and the branch by controlling a voltage application mode of the patch array of the microstrip filter 910 (i.e., which patch is applied with a voltage and which patch is not applied with a voltage) to achieve the corresponding filter effect.

In some examples, the electronic device 91 may be any product or component with communication function such as a cellphone, a navigation device, a game machine, a television (TV), a car audio, a tablet computer, a Personal Multimedia Player (PMP), a Personal Digital Assistant (PDA), etc. However, this embodiment is not limited thereto.

Accompanying drawings of the present disclosure only involve structures involved in the present disclosure, and other structures may refer to conventional designs. The embodiments of the present disclosure, i.e., features in the embodiments, may be combined with each other to obtain new embodiments if there is no conflict. It should be noted that the above examples or embodiments are exemplary only and not restrictive. Therefore, the present disclosure is not limited to what is specifically shown and described herein. Various modifications, substitutions or omissions may be made to the form and details of implementation without departing from the scope of the present disclosure.

1. A microstrip filter, comprising:
a first substrate and a second substrate disposed oppositely, and a dielectric layer disposed between the first substrate and the second substrate;
wherein the first substrate comprises a first base substrate and a patch array disposed on a side of the first base substrate close to the dielectric layer;
the second substrate comprises a second base substrate, a microstrip line disposed on a side of the second base substrate close to the dielectric layer, and a ground layer disposed on a side of the second base substrate away from the microstrip line; wherein the microstrip line comprises a main transmission line and at least one branch; and
an orthographic projection of the at least one branch of the microstrip line on the first base substrate overlaps with an orthographic projection of the patch array on the first base substrate, and the dielectric layer is configured to adjust a resonant frequency between the patch array and the microstrip line when a voltage is applied to a patch of the patch array.

2. The microstrip filter according to claim 1, wherein the microstrip line comprises a plurality of branches disposed symmetrically with respect to the main transmission line.

3. The microstrip filter according to claim 2, wherein the microstrip line comprises eight branches disposed symmetrically with respect to the main transmission line.

4. The microstrip filter according to claim 1, wherein the microstrip line comprises a plurality of branches, and the plurality of branches are connected on a same side of the main transmission line.

5. The microstrip filter according to claim 4, wherein the microstrip line comprises four branches, and the four branches are connected on the same side of the main transmission line.

6. The microstrip filter according to claim 1, wherein an extension direction of a branch of the microstrip line is perpendicular to an extension direction of the main transmission line.

7. The microstrip filter according to claim 1, wherein the patch array comprises a plurality of types of patches, and patches of a same type have a same shape and a same size; and one type of patches corresponds to one tunable center frequency.

8. The microstrip filter according to claim 7, wherein the orthographic projection of the at least one branch of the microstrip line on the first base substrate overlaps with all of orthographic projections of a plurality of patches of the patch array on the first base substrate, and the plurality of patches overlapped with the same branch are of different types.

9. The microstrip filter according to claim 8, wherein the plurality of patches overlapped with an orthographic projection of the same branch on the first base substrate are arranged in order of size from small to large in a direction away from the main transmission line

10. The microstrip filter according to claim 7, wherein at least one type of patches each has a slotted region, and an orthographic projection of the slotted region on the first base substrate overlaps with an orthographic projection of a branch of the microstrip line on the first base substrate.

11. The microstrip filter according to claim 10, wherein the orthographic projection of the slotted region on the first base substrate is rectangular.

12. The microstrip filter according to claim 7, wherein orthographic projections of at least one type of patches on the first base substrate are rectangular.

13. The microstrip filter according to claim 7, wherein the first substrate further comprises a plurality of drive electrode lines disposed on the first base substrate, and a plurality of patches of a same type are connected to a same drive electrode line.

14. The microstrip filter according to claim 1, wherein the first substrate further comprises a first alignment layer on a side of the patch array close to the dielectric layer; and the second substrate further comprises a second alignment layer on a side of the microstrip line close to the dielectric layer.

15. The microstrip filter according to claim 1, wherein the dielectric layer comprises a liquid crystal layer.

16. A driving method of the microstrip filter according to claim 1, comprising:
applying a voltage to at least one patch in the patch array to change a dielectric constant of the dielectric layer between the at least one patch and a branch so as to control a resonant frequency between the at least one patch and the microstrip line.

17. An electronic device comprising the microstrip filter according to claim 1.

18. An indoor distribution system comprising the microstrip filter according to claim 1.

19. The indoor distribution system according to claim 18, comprising: an indoor distribution source module, an intermediate module, and an indoor distribution antenna module, wherein the intermediate module is connected between the indoor distribution source module and the indoor distribution antenna module, and
the indoor distribution antenna module comprises a filter mixing unit and a plurality of antennas, the filter mixing unit is connected to the intermediate module and the plurality of antennas, and the filter mixing unit comprises at least one microstrip filter.

20. The microstrip filter according to claim 2, wherein the patch array comprises a plurality of types of patches, and patches of a same type have a same shape and a same size; and one type of patches corresponds to one tunable center frequency.
